(19) United States
(12) Patent Application Publication
(10) Pub. No.: US 2022/0350973 A1
(43) Pub. Date: Nov. 3, 2022

(54) APPARATUS AND METHOD FOR PREPROCESSING TEXT

(71) Applicant: DEEPBRAIN AI INC., Seoul (KR)

(72) Inventors: Jae Seong YOU, Seoul (KR); Gyeong Su CHAE, Seoul (KR); Se Young JANG, Seoul (KR)

(21) Appl. No.: 17/763,756

(22) PCT Filed: May 4, 2021
(86) PCT No.: PCT/KR2021/005600

§ 371 Date: Mar. 25, 2022

(30) Foreign Application Priority Data
Aug. 3, 2020 (KR) 10-2020-0096831

(51) Int. Cl. G06F 40/40; G10L 13/08

(52) U.S. Cl. CPC G06F 40/40; G10L 13/08

(57) ABSTRACT

An apparatus for preprocessing text according to a disclosed embodiment includes an acquisition unit that acquires text data including a plurality of grapheme, a conversion unit that converts the plurality of graphemes into a plurality of phonemes on the basis of previously set conversion rules, and a generation unit that generates one or more tokens by grouping the plurality of phonemes, by previously set number units, on the basis of an order in which the plurality of graphemes are depicted.

### CROSS REFERENCE TO RELATED APPLICATIONS AND CLAIM OF PRIORITY

This application claims benefit under 35 U.S.C. 119, 120, 121, or 365(c), and is a National Stage entry from International Application No. PCT/KR2021/005600, filed May 4, 2021, which claims priority to the benefit of Korean Patent Application No. 10-2020-0096831 filed in the Korean Intellectual Property Office on Aug. 3, 2020, the entire contents of which are incorporated herein by reference.

### BACKGROUND

### 1. Technical Field

Disclosed embodiments relate to text preprocessing technology for text-to-speech conversion.

### 2. Background Art

As the technology in the field of natural language processing has recently developed rapidly, the technology related to a text-to-speech (TTS) service that provides a function of uttering the contents of text data input by receiving arbitrary text data as input and converting the text data into speech data is also evolving. The development of this TTS service is due to the development of an artificial intelligence (AI)-based model that performs TTS.

However, in order for the AI-based model that performs TTS to provide high-quality TTS service, training using numerous text data and speech data is essential. However, in the case of Hangeul, it is difficult to achieve high-performance training results because the amount of data required for training is too large because the theoretically possible combinations of Hangeul are very diverse, and thus many errors occur even when performing TTS.

### SUMMARY

Disclosed embodiments are to provide a means for preprocessing text to be converted for text-to-speech conversion.

An apparatus for preprocessing text according to a disclosed embodiment includes an acquisition unit that acquires text data including a plurality of grapheme, a conversion unit that converts the plurality of graphemes into a plurality of phonemes on the basis of previously set conversion rules, and a generation unit that generates one or more tokens by grouping the plurality of phonemes, by previously set number units, on the basis of an order in which the plurality of graphemes are depicted.

The conversion unit may convert a vowel grapheme among the plurality of graphemes into a representative vowel phoneme included in a preset representative vowel set on the basis of the previously set conversion rules.

The conversion unit may convert a double final consonant grapheme among the plurality of graphemes into a single final consonant phoneme on the basis of the previously set conversion rules.

The conversion unit may convert a silent grapheme positioned at an initial consonant immediately after a double final consonant grapheme among the plurality of graphemes into an alternative consonant phoneme on the basis of the previously set conversion rules.

The conversion unit may harden graphemes ‘ [symbol] ’, ‘ [symbol] ’, ‘ [symbol] ’, ‘ [symbol] ’, and ‘ [symbol] ’ and positioned at initial consonants immediately after double final consonant graphemes ‘ [symbol] ’, ‘ [symbol] ’, ‘ [symbol] ’, ‘ [symbol] ’, and ‘ [symbol] ’ among the plurality of graphemes, on the basis of the previously set conversion rules.

The conversion unit may convert a keyek ( [symbol] ) grapheme positioned at a final consonant among the plurality of graphemes into a giyeok ( [symbol] ) phoneme, on the basis of the previously set conversion rules.

The generation unit may generate one or more bigrams by grouping the plurality of phonemes by two.

The generation unit may generate a token corresponding to a space or each of preset punctuation marks when the space corresponding to spacing or the preset punctuation marks exists in the text data.

A method for preprocessing text according to a disclosed embodiment includes a step of acquiring text data including a plurality of grapheme, a step of converting the plurality of graphemes into a plurality of phonemes on the basis of previously set conversion rules, and a step of generating one or more tokens by grouping the plurality of phonemes, by previously set number units, on the basis of an order in which the plurality of graphemes are depicted.

In the step of converting, a vowel grapheme among the plurality of graphemes may be converted into a representative vowel phoneme included in a preset representative vowel set on the basis of the previously set conversion rules.

In the step of converting, a double final consonant grapheme among the plurality of graphemes may be converted into a single final consonant phoneme on the basis of the previously set conversion rules.

In the step of converting, a silent grapheme positioned at an initial consonant immediately after a double final consonant grapheme among the plurality of graphemes may be converted into an alternative consonant phoneme on the basis of the previously set conversion rules.

In the step of converting, graphemes ‘ [symbol] ’, ‘ [symbol] ’, ‘ [symbol] ’, ‘ [symbol] ’, and ‘ [symbol] ’ positioned at initial consonants immediately after double final consonant graphemes ‘ [symbol] ’, ‘ [symbol] ’, ‘ [symbol] ’, ‘ [symbol] ’, and ‘ [symbol] ’ among the plurality of graphemes may be hardened, on the basis of the previously set conversion rules.

In the step of converting, a keyek ( [symbol] ) grapheme positioned at a final consonant among the plurality of graphemes may be converted into a giyeok ( [symbol] ) phoneme, on the basis of the previously set conversion rules.

In the step of generating, one or more bigrams may be generated by grouping the plurality of phonemes by two.

In the step of generating, a token corresponding to a space or each of preset punctuation marks may be generated when the space corresponding to spacing or the preset punctuation marks exists in the text data.

According to the disclosed embodiments, it is possible to reduce the occurrence of errors when performing text-to-speech (TTS) by reducing the diversity of a grapheme-phoneme conversion, by performing the grapheme-phoneme conversion on the basis of previously set conversion rules.

In addition, according to the disclosed embodiments, it is possible to reduce the amount of data required for training an artificial intelligence-based model that performs TTS by generating tokens by grouping phonemes, by previously set number units, when performing the grapheme-phoneme conversion.

### BRIEF DESCRIPTION OF THE DRAWINGS

FIG. 1 is a block diagram for describing a system for text-to-speech conversion according to an embodiment.

FIG. 2 is a block diagram for describing an apparatus for preprocessing text according to an embodiment.

FIG. 3 is an exemplary diagram for describing a process of preprocessing text according to an embodiment.

FIG. 4 is a flowchart for describing a method for preprocessing text according to an embodiment.

FIG. 5 is a block diagram illustratively describing a computing environment including a computing device suitable for use in exemplary embodiments.

### DETAILED DESCRIPTION

Hereinafter, a specific embodiment of the present disclosure will be described with reference to the drawings. The following detailed description is provided to aid in a comprehensive understanding of the methods, apparatus and/or systems described herein. However, this is illustrative only, and the present disclosure is not limited thereto.

In describing the embodiments of the present disclosure, when it is determined that a detailed description of related known technologies related to the present disclosure may unnecessarily obscure the subject matter of the present disclosure, a detailed description thereof will be omitted. In addition, terms to be described later are terms defined in consideration of functions in the present disclosure, which may vary according to the intention or custom of users or operators. Therefore, the definition should be made based on the contents throughout this specification. The terms used in the detailed description are only for describing embodiments of the present disclosure, and should not be limiting. Unless explicitly used otherwise, expressions in the singular form include the meaning of the plural form. In this description, expressions such as “comprising” or “including” are intended to refer to certain features, numbers, steps, actions, elements, some or combination thereof, and it is not to be construed to exclude the presence or possibility of one or more other features, numbers, steps, actions, elements, some or combinations thereof, other than those described.

Hereinafter, ‘Text-To-Speech (TTS)’ refers to a technology that receives arbitrary text data and converts the received text data into speech data through which the content of the input text data is uttered.

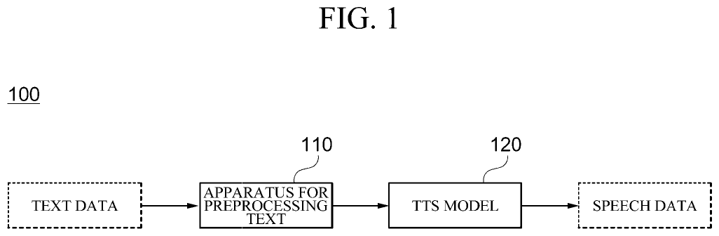

FIG. 1 is a block diagram for describing a system for text-to-speech conversion 100 according to an embodiment. As illustrated, the system for text-to-speech conversion 100 according to an embodiment includes an apparatus for preprocessing text 110 and a text-to-speech model 120.

Referring to FIG. 1, the apparatus for preprocessing text 110 receives text data written in Hangeul and processes the text data into data in a form that the text-to-speech conversion model 120 can convert.

The text-to-speech conversion model 120 is an artificial intelligence (AI)-based model that performs TTS, and receives processed text data as input and generates speech data through which the content of the received data is uttered.

According to one embodiment, the text-to-speech conversion model 120 may be trained by using learning methods such as supervised learning, unsupervised learning, reinforcement learning, etc. in a training process, but is not necessarily limited thereto.

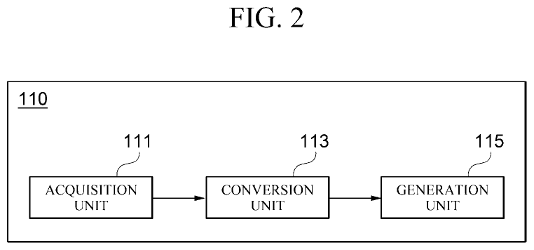

FIG. 2 is a block diagram for describing the apparatus for preprocessing text 110 according to an embodiment.

As illustrated, the apparatus for preprocessing text 110 according to an embodiment includes an acquisition unit 111, a conversion unit 113, and a generation unit 115.

In the illustrated embodiment, each component may have different functions and capabilities other than those described below, and may include additional components other than those described below.

In addition, in one embodiment, the acquisition unit 111, the conversion unit 113, and the generation unit 115 may be implemented using one or more physically separated devices, or may be implemented one or more processors or a combination of one or more processors and software, and may not be clearly distinguished in a specific operation unlike the illustrated example.

The acquisition unit 111 acquires text data including a plurality of graphemes.

In this case, according to an embodiment, the acquired text data may be text data written in Hangeul.

In addition, in the following embodiments, ‘grapheme’ means a character or character concatenation as a minimum distinguishing unit for indicating a phoneme in Hangeul. In addition, ‘phoneme’ means the smallest unit in phonology that cannot be further subdivided in Korean language.

The conversion unit 113 converts a plurality of graphemes into a plurality of phonemes based on previously set conversion rules.

In this case, the ‘conversion rules’ are rules for conversion between a grapheme and a phoneme, which are set in advance in order to reduce the diversity in the conversion of grapheme-phoneme, and it is obvious that the ‘conversion rules’ can be set in various ways according to embodiments.

According to an embodiment, the converter 113 may convert a vowel grapheme among a plurality of graphemes into a representative vowel phoneme included in a preset representative vowel set on the basis of previously set conversion rules.

Specifically, there are a total of 21 vowels in Hangeul, consisting of 10 short vowels ‘ [symbol] ’, ‘ [symbol] ’, ‘ [symbol] ’, [symbol] ’, ‘ [symbol] ’, ‘ [symbol] ’, ‘ [symbol] ’, ‘ [symbol] ’, ‘ [symbol] ’, and ‘ [symbol] ’) and 11 diphthongs (‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, and ‘ [symbol] ’). The conversion unit 113 may reduce the diversity of vowel grapheme-vowel phoneme conversion by converting the twenty-one vowel graphemes into representative vowel phonemes, thereby reducing the occurrence of errors when performing TTS.

In addition, the ‘representative vowel set’ may include some phonetic symbols among phonetic symbols respectively corresponding to the pronunciations of vowel graphemes. In this case, the ‘representative vowel phoneme’ may mean a phonetic symbol included in the ‘representative vowel set’.

For example, the conversion unit 113 may convert vowel graphemes into a representative vowel phoneme according to Rule 1 below.

[Rule 1]
Convert vowel graphemes ‘ [symbol] ’ and ‘ [symbol] ’ into vowel phoneme ‘ [symbol] ’.
Convert vowel graphemes ‘ [symbol] ’ and ‘ [symbol] ’ into vowel phoneme ‘ [symbol] ’.
Convert vowel graphemes ‘ [symbol] ’, ‘ [symbol] ’, and ‘ [symbol] ’ to be unified into vowel phoneme ‘ [symbol] ’.

According to an embodiment, the conversion unit 113 may convert a double final consonant grapheme among the plurality of graphemes into a single final consonant phoneme on the basis of the previously set conversion rules.

Specifically, there are a total of 19 consonants (‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, and ‘ [symbol] ’) in Hangeul, and when a consonant is positioned at a final consonant of a letter and functions as a support, it is called a ‘final consonant’.

In addition, ‘double final consonants’ means 9 final consonants (‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, and ‘ [symbol] ’) generated by mixing some of the 19 consonants among the final consonants, and ‘single final consonants’ means the rest of the final consonants except for the double final consonants.

That is, the conversion unit 113 may reduce the diversity of the consonant grapheme-consonant phoneme conversion by converting the nine double final consonant graphemes into their corresponding single final phonemes, thereby reducing the occurrence of errors when performing TTS.

For example, the conversion unit 113 may convert a double final consonant grapheme into a single final consonant phoneme according to Rule 2 below.

[Rule 2]
Convert double final consonant grapheme ‘ [symbol] ’ into single final consonant phoneme ‘ [symbol] ’.
Convert double final consonant grapheme ‘ [symbol] ’ into single final consonant phoneme ‘ [symbol] ’.
Convert double final consonant grapheme ‘ [symbol] ’ into single final consonant phoneme ‘ [symbol] ’.
Convert double final consonant grapheme ‘ [symbol] ’ into single final consonant phoneme ‘ [symbol] ’.
Convert double final consonant grapheme ‘ [symbol] ’ into single final consonant phoneme ‘ [symbol] ’, but if an initial consonant immediately after the double final consonant grapheme ‘ [symbol] ’ is ‘ [symbol] ’, the double final consonant grapheme ‘ [symbol] ’ is converted into the single final consonant phoneme ‘ [symbol] ’.

According to an embodiment, the conversion unit 113 may convert a silent grapheme, which is positioned at an initial consonant immediately after a double final consonant grapheme among the plurality of graphemes, into an alternative consonant phoneme, on the basis of previously set conversion rules.

Specifically, the ‘silent grapheme’ refers to the yi-eung ( [symbol] ) grapheme positioned at the initial consonant, and ‘alternative consonant grapheme’ is determined by reflecting the effect on pronunciation of the double final consonant positioned at the final consonant immediately before the silent grapheme.

For example, according to Rule 3 below, the conversion unit 113 may convert a silent grapheme positioned at the initial consonant immediately after a double final consonant grapheme into an alternative consonant grapheme, or harden convert some graphemes positioned at the initial consonants immediately after the double consonant grapheme.

[Rule 3]
Convert A ‘ [symbol] ’ grapheme positioned at initial consonant immediately after double final consonant grapheme ‘ [symbol] ’ into ‘ [symbol] ’ phoneme.
Convert ‘ [symbol] ’ grapheme positioned at an initial consonant immediately after double final consonant grapheme ‘ [symbol] ’ into ‘ [symbol] ’ phoneme.
Convert ‘ [symbol] ’ grapheme positioned at an initial consonant immediately after double final consonant grapheme ‘ [symbol] ’ into ‘ [symbol] ’ phoneme.
Convert ‘ [symbol] ’ grapheme positioned at an initial consonant immediately after double final consonant grapheme ‘ [symbol] ’ into ‘ [symbol] ’ phoneme.
Convert ‘ [symbol] ’ grapheme positioned at an initial consonant immediately after double final consonant grapheme ‘ [symbol] ’ into ‘ [symbol] ’ phoneme.
Harden graphemes ‘ [symbol] ’, ‘ [symbol] ’, ‘ [symbol] ’, ‘ [symbol] ’, and ‘ [symbol] ’, which are positioned at initial consonants immediately after double final consonant graphemes ‘ [symbol] ’, ‘ [symbol] ’, ‘ [symbol] ’, ‘ [symbol] ’, and ‘ [symbol] ’, to be respectively converted into ‘ [symbol] ’, ‘ [symbol] ’, ‘ [symbol] ’, ‘ [symbol] ,’ and ‘ [symbol] ’.

According to an embodiment, the conversion unit 113 may convert a keyek ( [symbol] ) grapheme positioned at a final consonant among the plurality of graphemes into a giyeok ( [symbol] ) phoneme on the basis of the previously set conversion rules.

The generation unit 115 generates one or more tokens by grouping, by previously set number units, the plurality of phonemes on the basis of the order in which the plurality of grapheme are described.

Hereinafter, ‘token’ refers to a logically distinguishable classification element in Hangeul or Korean language. For example, each single phoneme may be defined as a token or each syllable may be defined as a token.

For example, when a plurality of graphemes are depicted in horizontal writing in a left-to-right (or right-to-left) direction, the generation unit 115 may perform grouping of phonemes in the left-to-right (or right-to-left) direction.

As another example, when a plurality of graphemes are depicted in vertical writing from a top-to-bottom direction, the generation unit 115 may perform grouping of phonemes in the top-to-bottom direction.

According to an embodiment, the generation unit 115 may generate one or more bigrams by grouping the plurality of phonemes by two.

Hereinafter, ‘bigram’ means a sequence consisting of two adjacent phonemes in a character string including the plurality of phonemes.

For example, the generation unit 115 may generate a total of four bigrams (‘ [symbol] , [symbol] ’, ‘ [symbol] , [symbol] ’, ‘ [symbol] , [symbol] ’, and ‘ [symbol] , [symbol] ’) for the character string ‘ [symbol] ’.

According to an embodiment, when a space corresponding to spacing exists between a plurality of phonemes, the generation unit 115 may generate a token corresponding to each space.

For example, the generation unit 115 may generate one token corresponding to the space between ‘ [symbol] ’ and ‘ [symbol] [symbol] ’ for the character string ‘ [symbol] ’ to thereby generate a total of 11 tokens (‘ [symbol] , [symbol] ’, ‘ [symbol] , [symbol] ’, ‘ [symbol] , [symbol] ’, ‘ [symbol] , [symbol] ’, ‘ [symbol] ‘ [symbol] , [symbol] , ‘ [symbol] , [symbol] ’, ‘ [symbol] , [symbol] ’, ‘ [symbol] , [symbol] ’, and ‘ [symbol] , [symbol] ’) consisting of 9 bigrams and 1 token corresponding to the space.

According to an embodiment, when preset punctuation marks exist in the text data acquired by the acquisition unit 111, the generation unit 115 may generate tokens respectively corresponding to the punctuation marks.

For example, when at least one of four punctuation marks of a comma ( [symbol] ), a period ( [symbol] ), a question mark ( [symbol] ), and an exclamation point ( [symbol] ) exists in the text data acquired by the acquiring unit 111, the generation unit 115 may generate tokens ( [symbol] , [symbol] , [symbol] , and [symbol] ) corresponding to the punctuation marks.

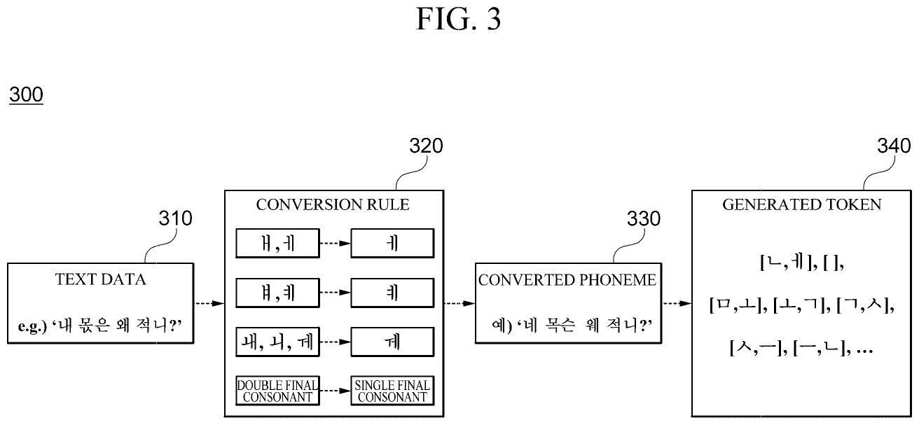

FIG. 3 is an exemplary diagram 300 for describing a process of preprocessing text according to an embodiment. The process illustrated in FIG. 3 may be performed, for example, by the apparatus for preprocessing text 110 described above.

First, it is assumed that text data 310 of a grapheme of ‘ [symbol] ’ is input to the apparatus for preprocessing text 110.

The input text data 310 is converted into phoneme data 330 of ‘ [symbol] ’ according to previously set conversion rules 320 in the apparatus for preprocessing text 110.

Specifically, the vowel grapheme ‘ [symbol] ’ of ‘ [symbol] ’ is converted into the representative vowel phoneme ‘ [symbol] ’ according to the conversion rule 320 of the first line, the double final consonant grapheme ‘ [symbol] ’ and the subsequent silent consonant ‘ [symbol] ’ of ‘ [symbol] ’ are converted into a single final consonant phoneme ‘ [symbol] ’ and an alternate consonant phoneme ‘ [symbol] ’, respectively, according to the conversion rule 320 of the fourth line, and the vowel grapheme ‘ [symbol] ’ of ‘ [symbol] ’ is converted into the representative vowel phoneme ‘ [symbol] ’ according to the conversion rule 320 of the third line.

Thereafter, the apparatus for preprocessing text 110 generates a token 340 using the converted phoneme 330 and a space corresponding to spacing. The token 340 of FIG. 3 is illustrated in the form of a token corresponding to bigrams and space generated by grouping the converted phonemes 330 by two.

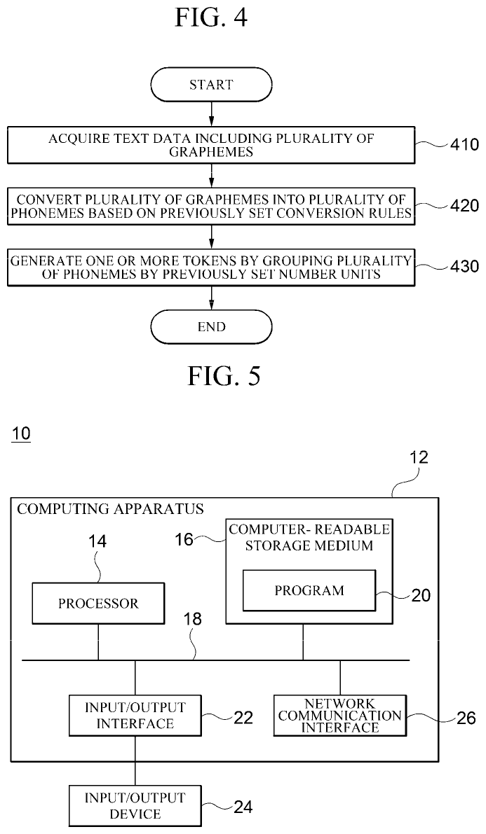

FIG. 4 is a flowchart illustrating a method for preprocessing text according to an embodiment. The method illustrated in FIG. 4 may be performed by, for example, the apparatus for preprocessing text 110 described above.

First, the apparatus for preprocessing text 110 acquires text data including a plurality of graphemes (410).

Thereafter, the apparatus for preprocessing text 110 converts the plurality of graphemes into a plurality of phonemes on the basis of previously set conversion rules (420).

Thereafter, the apparatus for preprocessing text 110 generates one or more tokens by grouping the plurality of phonemes, by previously set number units, on the basis of the order in which the plurality of grapheme are depicted (430).

In the illustrated flowchart, the method is described by dividing the method into a plurality of steps, but at least some of the steps may be performed in a different order, may be performed in combination with other steps, may be omitted, may be performed by dividing into detailed sub-steps, or may be performed by being added with one or more steps (not illustrated).

FIG. 5 is a block diagram illustratively describing a computing environment 10 including a computing device according to an embodiment. In the illustrated embodiment, respective components may have different functions and capabilities other than those described below, and may include additional components in addition to those described below.

The illustrated computing environment 10 includes a computing device 12. In one embodiment, the computing device 12 may be the apparatus for preprocessing text 110.

The computing device 12 includes at least one processor 14, a computer-readable storage medium 16, and a communication bus 18. The processor 14 may cause the computing device 12 to operate according to the exemplary embodiment described above. For example, the processor 14 may execute one or more programs stored on the computer-readable storage medium 16. The one or more programs may include one or more computer-executable instructions, which, when executed by the processor 14, may be configured to cause the computing device 12 to perform operations according to the exemplary embodiment.

The computer-readable storage medium 16 is configured such that the computer-executable instruction or program code, program data, and/or other suitable forms of information are stored. A program 20 stored in the computer-readable storage medium 16 includes a set of instructions executable by the processor 14. In one embodiment, the computer-readable storage medium 16 may be a memory (volatile memory such as a random access memory, non-volatile memory, or any suitable combination thereof), one or more magnetic disk storage devices, optical disk storage devices, flash memory devices, other types of storage media that are accessible by the computing device 12 and capable of storing desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 through the input/output interface 22. The exemplary input/output device 24 may include a pointing device (such as a mouse or trackpad), a keyboard, a touch input device (such as a touch pad or touch screen), a voice or sound input device, input devices such as various types of sensor devices and/or photographing devices, and/or output devices such as a display device, a printer, a speaker, and/or a network card. The exemplary input/output device 24 may be included inside the computing device 12 as a component constituting the computing device 12, or may be connected to the computing device 12 as a separate device distinct from the computing device 12.

Meanwhile, the embodiment of the present disclosure may include a program for performing the methods described in this specification on a computer, and a computer-readable recording medium containing the program. The computer-readable recording medium may contain program instructions, local data files, local data structures, etc., alone or in combination. The computer-readable recording medium may be specially designed and configured for the present invention, or may be commonly used in the field of computer software. Examples of computer-readable recording media include magnetic media such as a hard disk, a floppy disk, and a magnetic tape, optical recording media such as a CD-ROM and a DVD, and hardware devices such as a ROM, a RAM, a flash memory, etc., that are specially configured for storing and executing program instructions. Examples of the program may include a high-level language code that can be executed by a computer using an interpreter, etc., as well as a machine language code generated by a compiler.

Although the present disclosure has been described in detail through representative embodiments above, those skilled in the art to which the present disclosure pertains will understand that various modifications may be made thereto within the limits that do not depart from the scope of the present disclosure. Therefore, the scope of rights of the present disclosure should not be limited to the described embodiments, but should be defined not only by claims set forth below but also by equivalents of the claims.

1. An apparatus for preprocessing text, the apparatus comprising:
an acquisition unit configured to acquire text data including a plurality of grapheme;
a conversion unit configured to convert the plurality of graphemes into a plurality of phonemes on the basis of previously set conversion rules; and
a generation unit configured to generate one or more tokens by grouping the plurality of phonemes, by previously set number units, on the basis of an order in which the plurality of graphemes are depicted.

2. The apparatus according to claim 1, wherein the conversion unit is configured to convert a vowel grapheme among the plurality of graphemes into a representative vowel phoneme included in a preset representative vowel set on the basis of the previously set conversion rules.

3. The apparatus according to claim 1, wherein the conversion unit is configured to convert a double final consonant grapheme among the plurality of graphemes into a single final consonant phoneme on the basis of the previously set conversion rules.

4. The apparatus according to claim 1, wherein the conversion unit is configured to convert a silent grapheme positioned at an initial consonant immediately after a double final consonant grapheme among the plurality of graphemes into an alternative consonant phoneme on the basis of the previously set conversion rules.

5. The apparatus according to claim 1, wherein the conversion unit is configured to harden graphemes ‘ [symbol] ’, ‘ [symbol] ’, ‘ [symbol] ’, ‘ [symbol] ’, and ‘ [symbol] ’ positioned at initial consonants immediately after double final consonant graphemes ‘ [symbol] ’, ‘ [symbol] ’, ‘ [symbol] ’, ‘ [symbol] ’, and ‘ [symbol] ’ among the plurality of graphemes, on the basis of the previously set conversion rules.

6. The apparatus according to claim 1, wherein the conversion unit is configured to convert a keyek ( [symbol] ) grapheme positioned at a final consonant among the plurality of graphemes into a giyeok ( [symbol] ) phoneme, on the basis of the previously set conversion rules.

7. The apparatus according to claim 1, wherein the generation unit is configured to generate one or more bigrams by grouping the plurality of phonemes by two.

8. The apparatus according to claim 1, wherein the generation unit is configured to generate a token corresponding to a space or each of preset punctuation marks when the space corresponding to spacing or the preset punctuation marks exists in the text data.

9. A method for preprocessing text comprising:
acquiring text data including a plurality of grapheme;
converting the plurality of graphemes into a plurality of phonemes on the basis of previously set conversion rules; and
generating one or more tokens by grouping the plurality of phonemes, by previously set number units, on the basis of an order in which the plurality of graphemes are depicted.

10. The method according to claim 9, wherein, in the converting, a vowel grapheme among the plurality of graphemes is converted into a representative vowel phoneme included in a preset representative vowel set on the basis of the previously set conversion rules.

11. The method according to claim 9, wherein, in the converting, a double final consonant grapheme among the plurality of graphemes is converted into a single final consonant phoneme on the basis of the previously set conversion rules.

12. The method according to claim 9, wherein, in the converting, a silent grapheme positioned at an initial consonant immediately after a double final consonant grapheme among the plurality of graphemes is converted into an alternative consonant phoneme on the basis of the previously set conversion rules.

13. The method according to claim 9, wherein, in the converting, graphemes ‘ [symbol] ’, ‘ [symbol] ’, ‘ [symbol] ’, ‘ [symbol] ’, and ‘ [symbol] ’ positioned at initial consonants immediately after double final consonant graphemes ‘ [symbol] ’, ‘ [symbol] ’, ‘ [symbol] ’, ‘ [symbol] ’, and ‘ [symbol] ’ among the plurality of graphemes are hardened, on the basis of the previously set conversion rules.

14. The method according to claim 9, wherein, in the converting, a keyek ( [symbol] ) grapheme positioned at a final consonant among the plurality of graphemes is converted into a giyeok ( [symbol] ) phoneme, on the basis of the previously set conversion rules.

15. The method according to claim 9, wherein, in the generating, one or more bigrams are generated by grouping the plurality of phonemes by two.

16. The method according to claim 9, wherein, in generating, a token corresponding to a space or each of preset punctuation marks is generated when the space corresponding to spacing or the preset punctuation marks exists in the text data.
